(19) United States
(12) Patent Application Publication
(10) Pub. No.: US 2006/0112538 A1
(43) Pub. Date: Jun. 1, 2006

(54) Layer lamination integrated direct methanol fuel cell and a method of fabricating the same

(75) Inventors: Tsang-Ming Chang, Taipei (TW); Hsi-Ming Shu, Taipei (TW); Feng-Yi Deng, Taipei (TW)

Correspondence Address: G .LINK Co., LTD, Suite137 ,PmB 174, 931 West, 75th Street, NAPERVILLE, IL, 60565, US

(73) Assignee: ANTIG TECHNOLOGY Co, Ltd.

(21) Appl. No.: 10/996,858

(22) Filed: Nov. 26, 2004

(51) Int. Cl. H01M 8/00; H01M 6/00

(52) U.S. Cl. 29/623.1; 29/623.5; 429/12

(57) ABSTRACT

The invention is disclosed a method of fabricating a layer lamination integrated direct methanol fuel cell. The first step is form a flow-channel/liquid-trench layer by using materials of a printed circuit board (PCB). The second step is to form a membrane electrode assembly layer. The third step is to form a controlling circuit layer by using PCB manufacturing process. The forth step is to join the flow-channel/liquid-trench layer, the membrane electrode assembly layer, and the controlling circuit layer to form a layer lamination integrated direct methanol fuel cell.

### FIELD OF THE INVENTION

The present invention relates to a method of fabricating a direct methanol fuel cell and in particular to a method of fabricating a layer lamination integrated direct methanol fuel cell by using printed circuit board (PCB) manufacturing process.

### BACKGROUND OF THE INVENTION

A prior art has disclosed a direct methanol fuel cell system including a detector for methanol and a method of fabricating the same which have several disadvantages as following. (a) The circuit design is not included in the fuel cell, such that the whole fuel cell could not be manufactured in one step. (b) The designed micro-pipe results in manufacturing difficulty and the mass-producing problems. (c) It is difficult to control the concentration of methanol solution. There is on adjustment mechanism in the fuel cell. (d) The improper design in the cathode results that it is difficult for air or oxygen outside the cell to entire the cathode for reacting, which depends on the temperature and the pressure inside the cell.

Another prior art has disclosed a planar fuel cell and a structure of the planar fuel cell substrate which have several disadvantages as following. (a) The circuit design is not included in the fuel cell, such that the whole fuel cell could not be manufactured in one step. (b) Once the reaction begins, the reaction would stop until the fuel material exhaust. The reaction mechanism can not be controlled. (c) The improper design in the cathode results that it is difficult for air or oxygen outside the cell to entire the cathode for reacting, which depends on the temperature and the pressure inside the cell. (d) The reaction product could not to eliminate, such as H2O.

U.S. Pat. No. 5,631,099 discloses a surface replica fuel cell. However, there are still several disadvantages in this disclosed technology. (a) The structure is too complicated to fabricate. (b) It's difficult to eliminate the reaction products, such as H2O. (c) It's difficult to provide the necessary air or oxygen.

In order to overcome those disadvantages of prior art mentioned above, the present invention utilizes print circuit board (PCB) manufacturing process as well known to fabricate a layer lamination integrated direct methanol fuel cell.

### SUMMARY OF THE INVENTION

Accordingly, an object of present the invention is to provide a method of fabricating a layer lamination integrated direct methanol fuel cell using print circuit board (PCB) manufacturing process.

Another object of the present invention is to provide a layer lamination integrated direct methanol fuel cell having light, thin, and small products.

To achieve the above objects, the present invention provides a method of fabricating a layer lamination integrated direct methanol fuel cell is provided. First, flow channels and liquid trenches are formed in a printed circuit board (PCB). Next, a membrane electrode assembly layer is formed. A controlling circuit layer is formed in another printed circuit board. Finally, the PCB with flow channels and liquid trenches, the membrane electrode assembly layer, and the PCB with the controlling circuit are joined sequentially to form a layer lamination integrated direct methanol fuel cell.

Further, to achieve the above objects, the present invention provides a layer lamination integrated direct methanol fuel cell, comprising the following means: a flow-channel/liquid-trench layer formed by materials of a printed circuit board (PCB); a membrane electrode assembly layer; and a controlling circuit layer formed by using PCB manufacturing process, wherein the flow-channel/liquid-trench layer, the membrane electrode assembly layer, and the controlling circuit layer are respectively manufactured and are joined together to form the layer lamination integrated direct methanol fuel cell.

Further, to achieve the above objects, the present invention provides A layer lamination integrated direct methanol fuel cell, comprising the following means: a flow-channel/liquid-trench layer formed by materials of a printed circuit board (PCB); a membrane electrode assembly layer interposed between a controlling circuit layer and the flow-channel/liquid-trench layer; and the controlling circuit layer formed by using PCB manufacturing process and joined with the membrane electrode assembly layer.

### BRIEF DESCRIPTION OF THE DRAWINGS

The present invention can be more fully understood by reading the subsequent detailed description and examples with references made to the accompanying drawings, wherein:

FIG. 1 is a flowchart of fabricating a layer lamination integrated direct methanol fuel cell according to one embodiment of the present invention;

FIG. 2 is an elevational view of a flow-channel/liquid-trench layer according to one embodiment of the present invention;

FIG. 3 is an elevational view of a membrane electrode assembly layer according to one embodiment of the present invention;

FIG. 4 is an elevational view of a circuit controlling layer according to one embodiment of the present invention; and

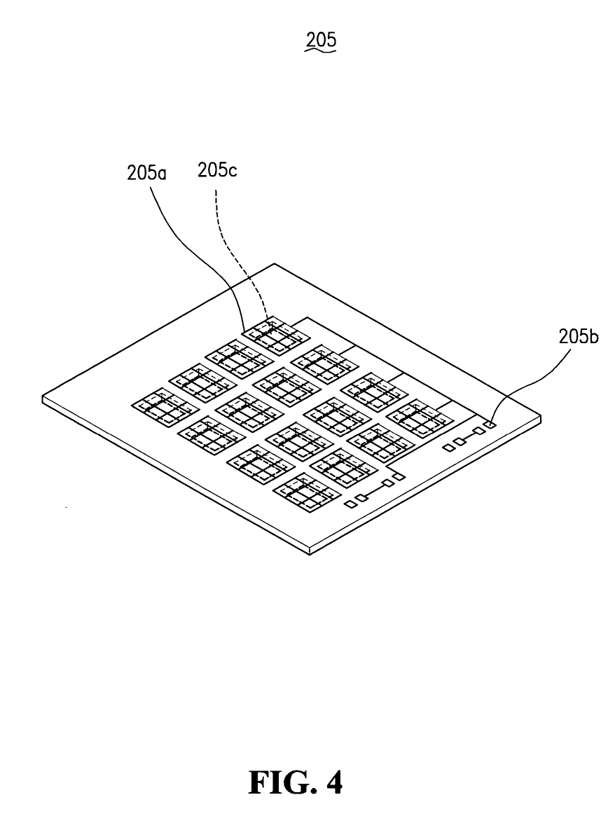

FIG. 5 is an elevational view of a layer lamination integrated direct methanol fuel cell according to one embodiment of the present invention.

### DETAILED DESCRIPTION OF THE INVENTION

A preferred embodiment of the present invention is now described with reference to the figures. The fabricating method 10 of the present invention is related to the layer lamination integrated direct methanol fuel cell 20 formation process. In accordance with the present invention, the print circuit board (PCB) is widely use for the material of the fuel cell, such as FR4. Compare to the method of fabricating the conventional fuel cell with high cost, the method of fabricating the fuel cell 20 according to the present invention has several advantages comprising easy manufacture, reduced cost, and fitting in with the modern product tendency.

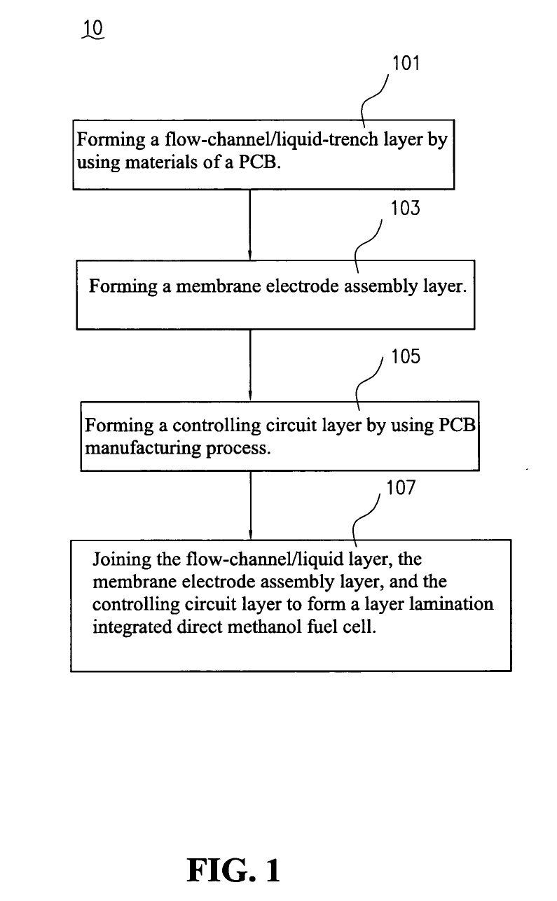

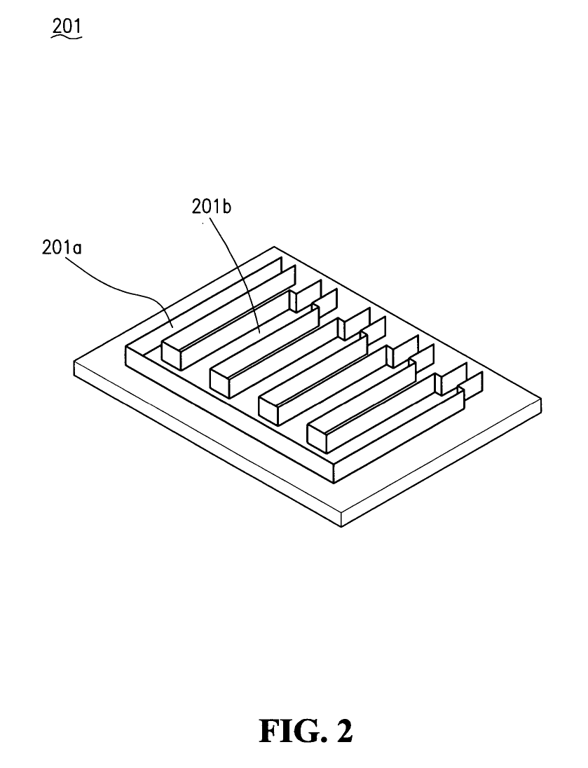

In accordance with the present invention, there is no any change in the property of the direct methanol fuel cell 20, and the light, thin, short, and small fuel cell could be fabricated easily. It definitely provides extremely convenience for portable small electric products, such as mobile phones, personal digital assistances (PDA), smart phones, e-books, tablet personal computers, and note books (NB). FIG. 1 shows a flowchart of fabricating a layer lamination integrated direct methanol fuel cell. The steps of the flowchart will be illustrated hereafter. In step 101, a flow-channel/liquid-trench layer 201 is formed in a printed circuit board (PCB). In FIG. 2, the materials of the printed circuit board used in step 101 can comprise FR4. According to an preferable embodiment of the step 101 of the present invention, the flow channels 201a with a preferable depth of 1˜10 mm are preferably formed in the FR4 substrate using a heat press machine, a laser molding equipment, and/or a CNC molding equipment. Next, the liquid trenches 201b are preferably formed in another substrate using a heat press machine, a laser molding equipment, and/or a CNC molding equipment. The flow channels 201a and liquid trenches 201b are preferably boned together by an adhesive material. The adhesive material can comprise a glass fiber reinforced epoxy resin. Finally, the stacked low channels 201a and liquid trenches 201b are preferably pressed by a heat press machine at a temperature of about 130° C.˜200° C. under a pressure of about 5˜50 kg/cm2.

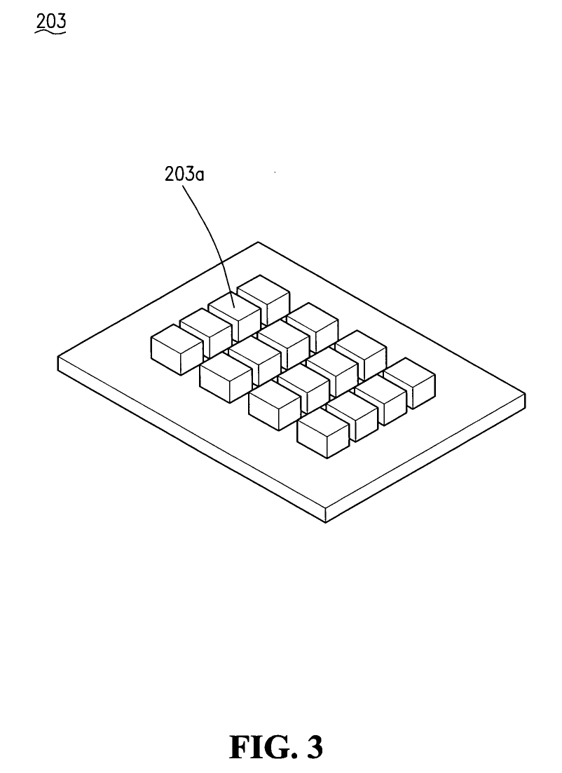

In step 103, a membrane electrode assembly layer 203 is formed. In FIG. 3, a material comprising Pt, Ru, or a combination thereof are coated on a proton exchange membrane and a polymer material. Next, the proton exchange membrane, a polymer catalytic layer, and a carbon paper or a carbon cloth are bonded by a glue to form the membrane electrode assembly layer 203. The material of the proton exchange membrane can be a DoPont Nafion. The coating step can be embodiment by using polyimide printing process. The material comprising Pt, Ru, or a combination thereof comprising a certain concentration of Pt is preferably formed by metal vacuum evaporation, metal vacuum sputtering, or electricless electroplate. The concentration of Pt is preferably about 1˜5 mg/cm2. The concentration of Pt/Ru is preferably about 1˜10 mg/cm2. The mixture of carbon, Teflon, and solvent is printed or pressed thereon. Therefore, the membrane electrode assembly 203 is complete. The membrane electrode assembly layer 203 can comprise a plurality of fuel cell unites 203a.

In step 105, a controlling circuit layer 205 is formed using PCB manufacturing process in a PCB. A plurality of holes are formed on the PCB by conversional drilling technology. A first Cu layer with a thickness of about 10˜50 μinch is preferably coated on the PCB by electroplating. A second Cu layer with a thickness of about 200˜500 μinch is then preferably coated on the first Cu layer by electroplating. Subsequently, after pressing, exposure, and development process, a Au layer with a thickness of about 3˜10 μinch is preferably formed on the second Cu layer. According to the designed layout of the controlling circuit layer 205 which may comprise a plurality of electric devices, circuit lines, and current collection circuit, the PCB is etched, and a protective paint is coated on the PCB. The controlling circuit layer 205 is complete. The controlling circuit layer 205 can be a double-side printed circuit board (PCB) or a multi-layer printed circuit board. Furthermore, in order to fit the fuel cell units 203a formed on the membrane electrode assembly layer 203, a plurality of current collection circuit 205a corresponding to the fuel cell units 203a, respectively, are formed on the controlling circuit layer 205. The under side of each current collection circuit 205a is a hollow area 205c which is corresponding to the fuel cell unit 203a.

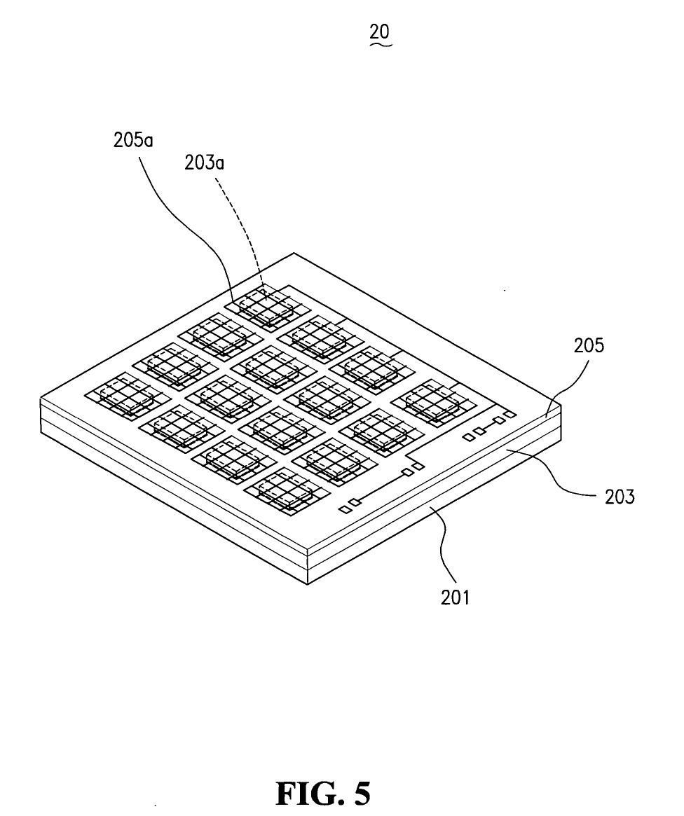

Finally, in step 107, the flow-channel/liquid-trench layer 201, the membrane electrode assembly layer 203, and the controlling circuit layer 205 are joined sequentially to form a layer lamination integrated direct methanol fuel cell 20. In FIG. 5, after the flow-channel/liquid-trench layer 201, the membrane electrode assembly layer 203, and the controlling circuit layer 205 are preferably stacked sequentially by an adhesive material or a glue through printing or stacking, the stacked layer lamination is pressed by the heat press machine to form the fuel cell 20. The adhesive material can be an epoxy. Furthermore, the step 107 of pressing can be performed at a temperature of about 80° C.˜180° C. under a pressure of about 2˜50 kg/cm2.

Next, fixing holes (not shown) are preferably formed in flow-channel/liquid-trench layer 201, the membrane electrode assembly layer 203, and the controlling circuit layer 205, respectively. The layers 201, 203, 205 are then preferably bonded by a glue, a screw, or a nail via the fixing holes.

The flow-channel/liquid-trench 201 formed in step 101 provide not only a function of storage of the fuel and H2O but also the anode reaction area. The controlling circuit layer 205 formed in step 105, comprising a plurality of SMT electric device 205b and layout circuit, provides not only a function of mechatronics control but also the cathode reaction area.

The layer lamination integrated direct methanol fuel cell 20 in accordance with the present invention 10 substantially comprises the flow-channel/liquid-trench layer 201 fabricated from a printed circuit board (PCB), the membrane electrode assembly layer 203, and the controlling circuit layer 205 fabricated from another printed circuit board PCB). After the layers 201, 203, 205 are fabricated respectively, all of them are joined to form the layer lamination integrated direct methanol fuel cell 20.

The layer lamination integrated direct methanol fuel cell 20 in accordance with the present invention 10 comprises the flow-channel/liquid-trench layer 201 fabricated from a printed circuit board (PCB) and joined with the membrane electrode assembly layer 203, the controlling circuit layer 205 fabricated from another printed circuit board (PCB), and the membrane electrode assembly layer 203 interposed between the controlling circuit layer 205 and the flow-channel/liquid-trench 201.

The method 10 of fabricating the layer lamination integrated direct methanol fuel cell 20 in accordance with the present invention can provide several advantages as follow. Fist, the fuel cell is fabricated integratedly, such that the cost of materials and manufacture can be reduced effectively to fit in with economical efficiency. Second, the method of fabricating the fuel cell 20 according to the present invent is suitable for mass-producing and provides standard processes. Third, it is convenient for the peripheral systems. Fourth, the life time of the fuel cell 20 according to the present invention is prolonged. Fifth, it is easy to get methanol fuel, and the methanol fuel can provide protection from corrosions and leakage. Sixth, it provides environmental protection. Seventh, it provides light, thin, and small properties.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of fabricating a layer lamination integrated direct methanol fuel cell, comprising:
forming a flow-channel/liquid-trench layer by using materials of a printed circuit board (PCB);
forming a membrane electrode assembly layer;
forming a controlling circuit layer by using PCB manufacturing process; and joining the flow-channel/liquid-trench layer, the membrane electrode assembly layer, and the controlling circuit layer to form a layer lamination integrated direct methanol fuel cell.

2. The method as claimed in claim 1, wherein the materials of the PCB comprise FR4.

3. The method as claimed in claim 2, wherein the step of forming the flow-channel/liquid-trench layer further comprises the following steps:
forming the flow channels in a PCB substrate by using a heat press machine, a laser molding equipment, and/or a CNC molding equipment;
forming the liquid trenches in another PCB substrate by using a heat press machine, a laser molding equipment, and/or a CNC molding equipment;
bonding the substrate with flow channels and the substrate with liquid trenches by an adhesive material; and
pressing the two substrates by a heat press machine.

4. The method as claimed in claim 3, wherein the depth of the flow channel is 1˜10 mm.

5. The method as claimed in claim 3, wherein the adhesive material comprises a glass fiber reinforced epoxy resin.

6. The method as claimed in claim 3, wherein the step of pressing is performed at a temperature of 130° C.˜200° C. under a pressure of about 5˜50 kg/cm2.

7. The method as claimed in claim 1, wherein the step of forming the membrane electrode assembly layer further comprises the following steps:
coating a material comprising Pt, Ru, or a combination thereof on a proton exchange membrane and a polymer material; and
bonding the proton exchange membrane, the polymer catalytic layer, and a carbon paper or a carbon cloth by a glue to form the membrane electrode assembly layer.

8. The method as claimed in claim 7, wherein the material of the proton exchange membrane comprises DoPont Nafion.

9. The method as claimed in claim 7, wherein the concentration of Pt material is 1˜5 mg/cm2.

10. The method as claimed in claim 7, wherein the concentration of the material comprising Pt and Ru is 1˜10 mg/cm2.

11. The method as claimed in claim 1, wherein the controlling circuit layer is a double-side print circuit board (PCB).

12. The method as claimed in claim 1, wherein the controlling circuit layer is a multi-layer print circuit board (PCB).

13. The method as claimed in claim 1, wherein the controlling circuit layer further comprises at least one print circuit board (PCB) and at least one electric device posited on the print circuit board (PCB).

14. The method as claimed in claim 1, wherein the step of joining further comprises the following steps:
stacking he flow-channel/liquid-trench layer, the membrane electrode assembly layer, and the controlling circuit layer by a glue or an adhesive material to form a stacked layer lamination;
pressing the stacked layer lamination by the heat press machine to form the layer lamination integrated direct methanol fuel cell.

15. The method as claimed in claim 14, wherein the adhesive material is an epoxy.

16. The method as claimed in claim 14, wherein the step of pressing is performed at a temperature of 80° C.˜180° C. under apressure of 2˜50 kg/cm2.

17. The method as claimed in claim 1, wherein further comprising the steps:
forming at least one fixing hole therein the flow-channel/liquid-trench layer, the membrane electrode assembly layer, and the controlling circuit layer, respectively; and
bonding the flow-channel/liquid-trench layer, the membrane electrode assembly layer, and the controlling circuit layer by a glue, a screw, or a nail via the fixing holes.

18. A layer lamination integrated direct methanol fuel cell, comprising:
a flow-channel/liquid-trench layer, formed by materials of a printed circuit board (PCB);
a membrane electrode assembly layer; and
a controlling circuit layer, formed by using PCB manufacturing process, wherein the flow-channel/liquid-trench layer, the membrane electrode assembly layer, and the controlling circuit layer are respectively manufactured and are joined together to form the layer lamination integrated direct methanol fuel cell.

19. A layer lamination integrated direct methanol fuel cell, comprising:
a flow-channel/liquid-trench layer, formed by materials of a printed circuit board (PCB);
a membrane electrode assembly layer, interposed between a controlling circuit layer and the flow-channel/liquid-trench layer; and
the controlling circuit layer, formed by using PCB manufacturing process and joined with the membrane electrode assembly layer.
